(19) United States
(12) Patent Application Publication
(10) Pub. No.: US 2026/0030728 A1
(43) Pub. Date: Jan. 29, 2026

(54) IMAGING DEVICE

(71) Applicant: Magnolia White Corporation, Tokyo (JP)

(72) Inventor: Tomoyuki ISHIHARA, Tokyo (JP)

(21) Appl. No.: 19/265,759

(22) Filed: Jul. 10, 2025

(30) Foreign Application Priority Data
Jul. 24, 2024 (JP) 2024-118784

(51) Int. Cl. G06T 5/73; G03B 19/16; G06T 3/4007; G06T 5/20

(52) U.S. Cl. CPC G06T 5/73; G03B 19/16; G06T 3/4007; G06T 5/20

(57) ABSTRACT

According to an aspect, an imaging device includes: a planar optical sensor comprising a plurality of photodiodes; a pinhole plate stacked in a first direction with respect to the optical sensor and provided with a plurality of pinholes; a storage circuit configured to store therein a first image indicating a light-dark pattern captured by the optical sensor in a state where a point light source faces the pinhole plate at a predetermined distance; and a processing circuit configured to perform image processing to generate a third image by performing an image restoration calculation process based on the first image and a second image that is obtained by capturing a subject using the optical sensor through the pinholes of the pinhole plate.

### CROSS-REFERENCE TO RELATED APPLICATION

This application claims the benefit of priority from Japanese Patent Application No. 2024-118784 filed on Jul. 24, 2024, the entire contents of which are incorporated herein by reference.

### BACKGROUND

### 1. Technical Field

What is disclosed herein relates to an imaging device.

### 2. Description of the Related Art

Japanese Patent Application Laid-open Publication No. 2024-001293 (JP-A-2024-001293) discloses an imaging device that includes a lens and an optical sensor (image pickup device). Light from a subject enters the optical sensor through the lens. Japanese Patent No. 5839428 (JP-5839428) discloses a pinhole camera. The pinhole camera includes a pinhole plate provided with a pinhole and an optical sensor (light-receiving element). The light from a subject enters the optical sensor through the pinhole of the pinhole plate.

The imaging device including the lens according to JP-A-2024-001293 needs to have a long focal length, which may increase the overall size of the device. In the pinhole camera according to JP-5839428, the amount of light passing through the pinhole is limited, which may make it difficult to capture clear images.

For the foregoing reasons, there is a need for an imaging device that has a smaller overall size and is capable of capturing clearer images with reduced blur.

### SUMMARY

According to an aspect, an imaging device includes: a planar optical sensor comprising a plurality of photodiodes; a pinhole plate stacked in a first direction with respect to the optical sensor and provided with a plurality of pinholes; a storage circuit configured to store therein a first image indicating a light-dark pattern captured by the optical sensor in a state where a point light source faces the pinhole plate at a predetermined distance; and a processing circuit configured to perform image processing to generate a third image by performing an image restoration calculation process based on the first image and a second image that is obtained by imaging a subject using the optical sensor through the pinholes of the pinhole plate.

### BRIEF DESCRIPTION OF THE DRAWINGS

FIG. 1A is a perspective view schematically illustrating an imaging device according to a first embodiment of the present disclosure;

FIG. 1B is a side view schematically illustrating the imaging device according to the first embodiment;

FIG. 2 is a block diagram illustrating a configuration example of the imaging device according to the first embodiment;

FIG. 3 is a schematic diagram illustrating a procedure of image processing according to the first embodiment;

FIG. 4 is a schematic diagram illustrating a point light source, a pinhole plate, and an optical sensor;

FIG. 5 is a flowchart illustrating a method for acquiring first image data according to the first embodiment;

FIG. 6 is a flowchart illustrating a method for acquiring third image data according to the first embodiment;

FIG. 7 is a schematic diagram explaining arrangements of pinholes;

FIG. 8 is a perspective view schematically illustrating an imaging device according to a second embodiment of the present disclosure;

FIG. 9 is a sectional view taken along line IX-IX in FIG. 8;

FIG. 10 is a schematic diagram illustrating a procedure of image processing according to the second embodiment;

FIG. 11 is a plan view of a pinhole plate according to a first modification;

FIG. 12 is a schematic sectional view of a pinhole plate according to a second modification;

FIG. 13 is an exploded perspective view schematically illustrating an imaging device according to a third embodiment of the present disclosure;

FIG. 14 is a schematic sectional view taken along line XIV-XIV in FIG. 13;

FIG. 15 is an enlarged schematic view of a portion of FIG. 14;

FIG. 16 is a schematic enlarged view of a code mask sheet; and

FIG. 17 is a schematic diagram illustrating a procedure of image processing according to the third embodiment.

### DETAILED DESCRIPTION

The following describes modes (embodiments) for carrying out the present disclosure in detail with reference to the drawings. The present disclosure is not limited to the description of the embodiments given below. Components described below include those easily conceivable by those skilled in the art or those substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In xyz coordinates, an x direction is, for example, a left-right direction, and an x1 side is opposite to an x2 side. The x1 side is also referred to as the left side, and the x2 side as the right side. A y direction is, for example, an up-down direction, and a y1 side is opposite to a y2 side. The y1 side is also referred to as the upper side, and the y2 side as the lower side. A z direction is, for example, a front-back direction or a thickness direction, and a z1 side is opposite to a z2 side. The z1 side is also referred to as the front side, and the z2 side as the back side. The z direction is also referred to as a first direction.

### First Embodiment

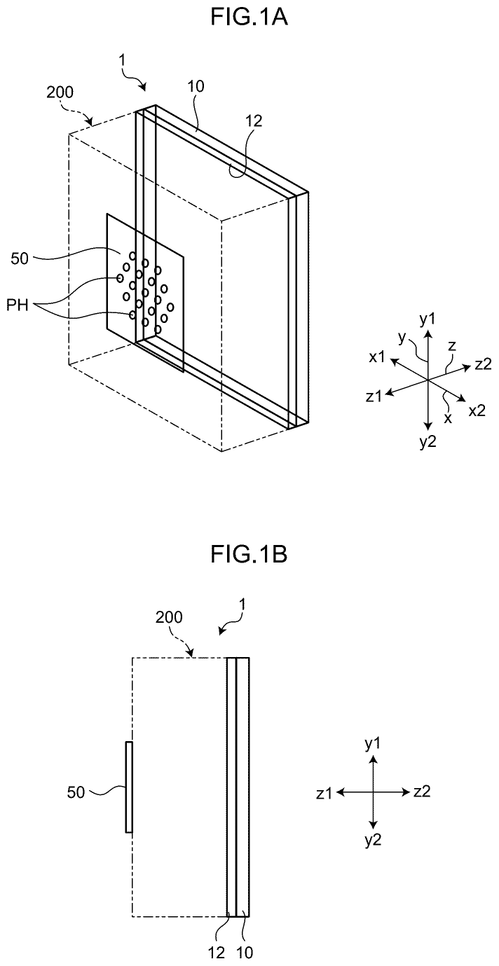

A first embodiment of the present disclosure will first be described. FIG. 1A is a perspective view schematically illustrating an imaging device according to the first embodiment. FIG. 1B is a side view schematically illustrating the imaging device according to the first embodiment. As illustrated in FIGS. 1A and 1B, an imaging device 1 includes a housing 200, an optical sensor 10, an optical filter layer 12, and a pinhole plate 50.

The housing 200 is a non-light-transmitting box. The housing 200 has front, back, top, bottom, and side surfaces. The pinhole plate 50 is provided, for example, on the front surface of the housing 200. A plurality of pinholes PH are formed in the pinhole plate 50. Specifically, the pinhole plate 50 is a flat plate-like member, and the pinholes PH are provided through the flat plate-like member. In the first embodiment, each of the pinholes PH is, for example, a small circular hole penetrating the non-light-transmitting flat plate. The arrangement of the pinholes PH will be described later.

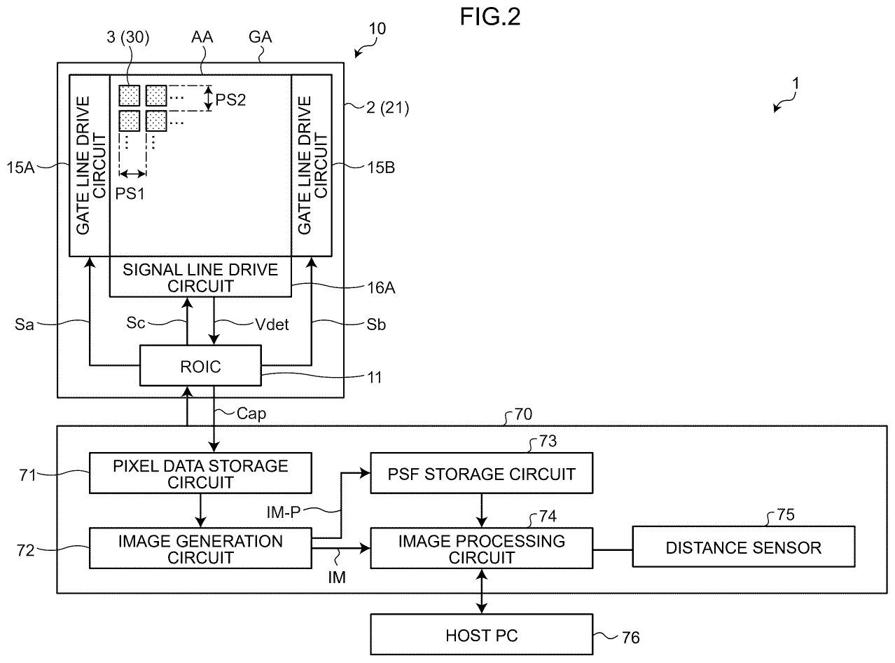

The optical sensor 10 and the optical filter layer 12 are provided, for example, on the back surface of the housing 200. The optical filter layer 12 is stacked on the z1 side of the optical sensor 10. The optical filter layer 12 is an optical element that limits the angular range of light transmitted through the optical filter layer 12, out of light that has passed through the pinholes PH. The optical filter layer 12 is also called collimating apertures or a collimator. The optical sensor 10 is a planar detection device that includes a plurality of photodiodes 30 (photodetection elements) arranged in a planar configuration. The optical sensor 10 is separated from the pinhole plate 50 in the z direction. The optical sensor 10 will be described later in detail with reference to FIG. 2. The optical sensor 10 and the pinhole plate 50 are arranged parallel to each other. In the embodiment, “plan view” denotes a state “viewed in a direction orthogonal to the optical sensor 10 or the pinhole plate 50” or “viewed in the z direction”.

FIG. 2 is a block diagram illustrating a configuration example of the imaging device according to the first embodiment. As illustrated in FIG. 2, the imaging device 1 further includes a control circuit 70 that controls the optical sensor 10. The control circuit 70 includes, for example, a micro control unit (MCU), a random-access memory (RAM), an electrically erasable programmable read-only memory (EEPROM), and a read-only memory (ROM).

The optical sensor 10 includes an array substrate 2, a plurality of sensor pixels 3 (photodiodes 30) formed on the array substrate 2, gate line drive circuits 15A and 15B, a signal line drive circuit 16A, and an imaging circuit (ROIC) 11. The imaging circuit 11 includes a readout integrated circuit.

The array substrate 2 is formed using a substrate 21 as a base. Each of the sensor pixels 3 is configured with a corresponding one of the photodiodes 30, a plurality of transistors, and various types of wiring. The array substrate 2 with the photodiodes 30 formed thereon is a drive circuit board for driving the sensor for each predetermined detection area and is also called a backplane or an active matrix substrate.

The substrate 21 has an active area AA and a peripheral area GA. The active area AA is an area provided with the sensor pixels 3 (photodiodes 30). The peripheral area GA is an area between the outer perimeter of the active area AA and the outer edges of the substrate 21 and is an area not provided with the sensor pixels 3. The gate line drive circuits 15A and 15B, the signal line drive circuit 16A, and the imaging circuit 11 are provided in the peripheral area GA.

Each of the sensor pixels 3 is an optical sensor including the photodiode 30 as a sensor element. Each of the photodiodes 30 outputs an electric signal corresponding to light emitted thereto. More specifically, the photodiode 30 is a positive-intrinsic-negative (PIN) photodiode or an organic photodiode (OPD) using an organic semiconductor. The sensor pixels 3 (photodiodes 30) are arranged in a matrix having a row-column configuration in the active area AA. The distance between adjacent two of the sensor pixels 3 (photodiodes 30) is a distance PS1 or PS2.

The imaging circuit 11 is a circuit that supplies control signals Sa, Sb, and Sc to the gate line drive circuits 15A and 15B, and the signal line drive circuit 16A, respectively, to control operations of these circuits. Specifically, the gate line drive circuits 15A and 15B output gate drive signals to gate lines based on the control signals Sa and Sb. The signal line drive circuit 16A electrically couples a signal line SLS selected based on the control signal Sc to the imaging circuit 11. The imaging circuit 11 includes a signal processing circuit that processes an imaging signal Vdet from each of the photodiodes 30.

The photodiodes 30 included in the sensor pixels 3 perform detection in response to the gate drive signals supplied from the gate line drive circuits 15A and 15B. Each of the photodiodes 30 outputs the electric signal corresponding to the light emitted thereto as the imaging signal Vdet to the signal line drive circuit 16A. The imaging circuit 11 is electrically coupled to the photodiodes 30. The imaging circuit 11 processes the imaging signal Vdet from each of the photodiodes 30 and outputs pixel data Cap based on the imaging signal Vdet to the control circuit 70. The pixel data Cap is a sensor value obtained for each of the sensor pixels 3.

The control circuit 70 includes, as control circuits for the optical sensor 10, a pixel data storage circuit 71, an image generation circuit 72, a point spread function (PSF) storage circuit (storage circuit) 73, an image processing circuit (processing circuit) 74, and a distance sensor 75. The pixel data storage circuit 71 stores therein the pixel data Cap output from the imaging circuit 11 of the optical sensor 10. The image generation circuit 72 generates a second image IM obtained by imaging a subject based on the pixel data Cap of the photodiodes 30.

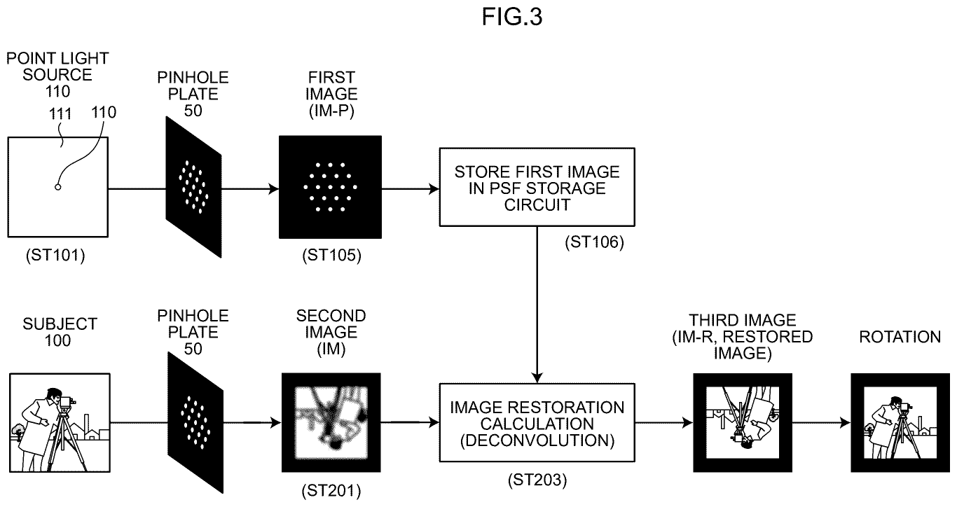

The PSF storage circuit 73 is also referred to as a “storage circuit”. The PSF storage circuit 73 stores therein a first image IM-P indicating a light-dark pattern captured by the optical sensor 10 in a state where a point light source 110 faces the pinhole plate 50 at a predetermined distance. In more detail, the PSF storage circuit 73 stores therein point spread function (PSF) data (point-image spread function) acquired based on the first image IM-P obtained by imaging the pinhole plate 50 (refer to FIG. 3) by the optical sensor 10 based on the light from the point light source 110.

The image processing circuit 74 is also referred to as a “processing circuit”. The image processing circuit 74 generates a third image IM-R by performing an image restoration calculation process based on the first image IM-P and the second image IM. As described above, the second image IM is an image obtained by imaging the photographic subject 100 using the optical sensor 10 through the pinholes PH of the pinhole plate 50. In the following embodiment, an example of application of a deconvolution process, for example, will be described as one aspect of the image restoration calculation process.

The distance sensor 75 detects the distance between the subject 100 and the pinhole plate 50. In detail, the distance sensor 75 detects the distance between the pinhole plate 50 and a portion of the subject 100 in focus of the imaging device 1.

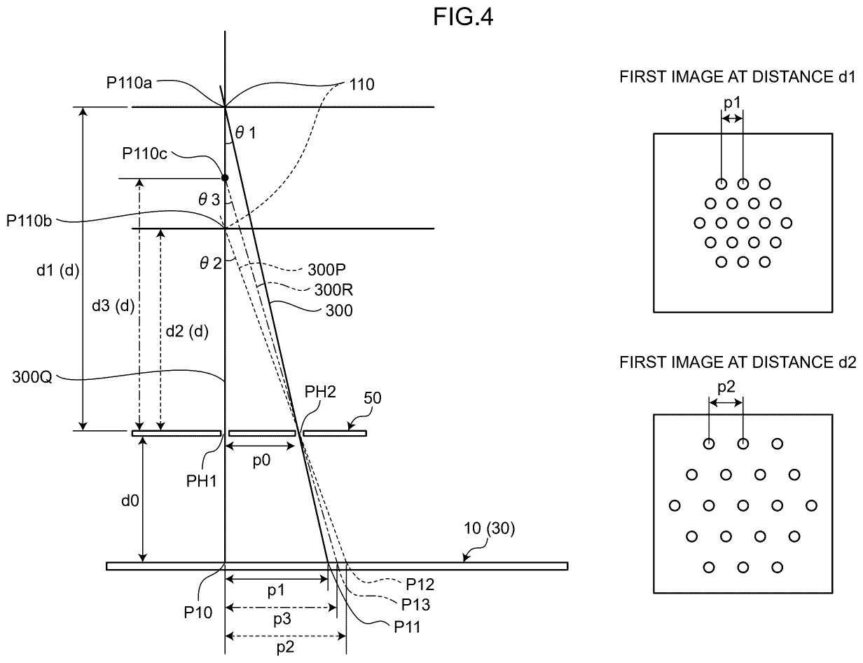

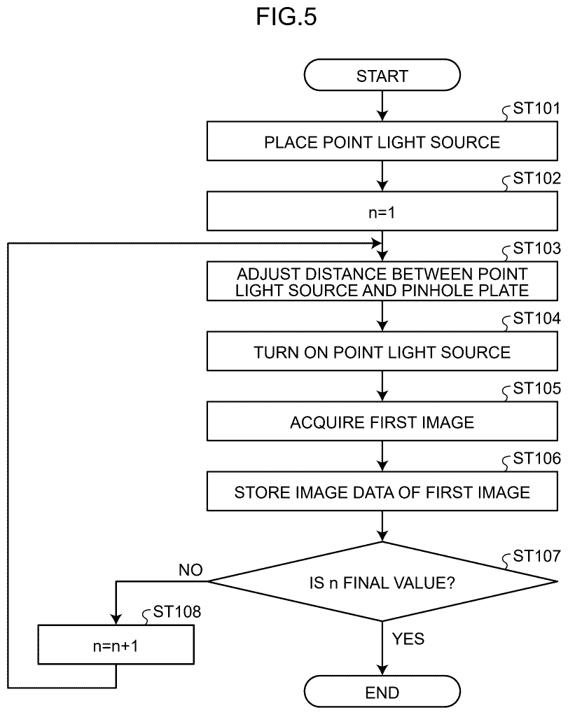

FIG. 3 is a schematic diagram illustrating a procedure of image processing according to the first embodiment. FIG. 4 is a schematic diagram illustrating the point light source, the pinhole plate, the optical sensor, and the first image. FIG. 5 is a flowchart illustrating a method for acquiring the first image data according to the first embodiment.

The method for acquiring the first image according to the first embodiment will be described with reference to FIGS. 3 and 5. As illustrated in FIGS. 3 and 5, an operator first places the point light source 110 (Step ST101). At Steps from ST102 to ST107, the imaging device 1 varies a distance d between the point light source 110 and the pinhole plate 50 in a direction orthogonal to a surface of the optical sensor 10 (refer to FIG. 4), and acquires a plurality of types of the first image for respective distances d(n).

Specifically, the control circuit 70 sets the number of times n of imaging of the pinhole plate 50 to 1 (Step ST102). The number of times n of imaging corresponds to the distance d(n) between the point light source 110 and the pinhole plate 50. The number of times n of imaging is set in advance according to specifications of the imaging device 1 (such as the distance between the optical sensor 10 and the pinhole plate 50) and the accuracy of restoration required for the deconvolution process to be described later.

Then, the distance d(n) between the point light source 110 and the pinhole plate 50 is adjusted (Step ST103).

Next, the point light source 110 is turned on (Step ST104). As a result, the light emitted from the point light source 110 irradiates the photodiodes 30 of the optical sensor 10, and the first image IM-P (refer to FIG. 3) is captured by the optical sensor 10 (Step ST105).

Next, the PSF storage circuit 73 (refer to FIG. 2) stores therein the first image IM-P (Step ST106). Specifically, the PSF storage circuit 73 stores therein the first image IM-P indicating the light-dark pattern captured by the optical sensor 10 in the state where the point light source 110 faces the pinhole plate 50 at the predetermined distance.

The control circuit 70 (refer to FIG. 2) then determines whether the number of times n of imaging is a final value (Step ST107). If the number of times n of imaging is not the final value (No at Step ST107), the control circuit 70 updates the number of times n of imaging of the pinhole plate 50 to n+1 (Step ST108).

The control circuit 70 performs the processes at Steps ST103 to ST106 described above to capture a plurality of the first images IM-P of the pinhole plate 50 while changing the distance d(n) between the point light source 110 and the pinhole plate 50 illustrated in FIG. 4. The control circuit 70 thereby stores the first images IM-P in the PSF storage circuit 73 such that the first images IM-P are associated with the distances d(n) between the point light source 110 and the pinhole plate 50. That is, the number of times n of imaging corresponds to the number of the first images IM-P.

If the number of times n of imaging is the final value (Yes at Step ST107), the control circuit 70 ends the acquisition of the first images IM-P.

In the flowchart in FIG. 5 described above, the first images IM-P are acquired by actually imaging the pinhole plate 50 while changing the distance d between the point light source 110 and the pinhole plate 50.

In the present disclosure, however, the first images IM-P can also be obtained by interpolation processing. The interpolation processing is processing to enlarge or shrink the first image IM-P into an image corresponding to the distance detected by the distance sensor 75 before the deconvolution process. The following briefly describes the interpolation processing with reference to FIG. 4.

The interpolation processing is image processing to obtain the first image by calculation, for example, when light 300R is emitted from a position P110c between a position P110a and a position P110b based on the two first images captured using light 300 and light 300P from the point light sources 110 located in the two adjacent positions (positions P110a and P110b). That is, before the image processing, the first images are captured when the light 300 and the light 300P are emitted from the positions P110a and P110b, respectively, and the first images by the light 300 and the light 300P are enlarged or shrunk to generate the first image to be acquired if the light 300R is emitted from the position P110c.

As illustrated in FIG. 4, the photodiodes 30 of the optical sensor 10 are irradiated with the light 300, the light 300P, and light 3000 that have emitted from the point light source 110 and passed through the pinholes PH of the pinhole plate 50. The light 300R passes through the pinhole PH from the position P110c and reaches the photodiode 30 of the optical sensor 10.

A projection image of the pinhole PH on the surface of the optical sensor 10 is expanded with respect to an actual shape (area) of the pinhole PH (refer to two schematic views on the right side of FIG. 4). As illustrated in FIG. 4, light emitted from the point light source 110 at a distance dl from the pinhole plate 50 and intersecting the optical sensor 10 at a right angle is the light 300Q. Light emitted from the point light source 110 at the distance d1 from the pinhole plate 50 and intersecting the light 300Q at an intersection angle θ1 is the light 300. Light emitted from the point light source 110 at a distance d2 from the pinhole plate 50 and intersecting the light 300Q at an intersection angle θ2 is the light 300P. The distance between the pinhole plate 50 and the optical sensor 10 is a distance d0.

The distance between a pinhole PH1 allowing the light 3000 to pass therethrough and a pinhole PH2 allowing the light 300 and 300P pass therethrough, among the pinholes PH provided in the pinhole plate 50, is a distance p0.

The position of the optical sensor 10 onto which the light 3000 is projected is a position P10. The position of the optical sensor 10 onto which the light 300 is projected is a position P11. The position of the optical sensor 10 onto which the light 300P is projected is a position P12. The distance between the positions P10 and P11 is a distance pl. The distance between the positions P10 and P12 is a distance p2. The distance p1=(d0+d1)tan(θ1), where θ1=tan⁻¹(p0/d1), and the distance p2=(d0+d2)tan(θ2).

When the light 300R is emitted from a position P110c, the position of the optical sensor 10 onto which the light 300R is projected is a position P13. The distance between the positions P10 and P13 is a distance p3. Since the light 300R intersects the light 300Q at an intersection angle θ3, the distance p3=(d0+d3)tan(θ3). Thus, the first image IM-P can also be obtained by the interpolation processing.

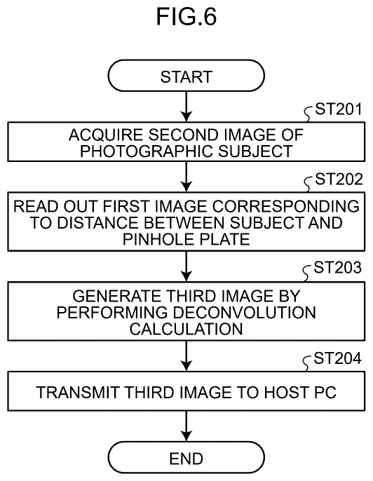

The following describes a method for generating the third image IM-R by performing the deconvolution process using the first image IM-P on the second image IM obtained by imaging the subject 100, with reference to FIGS. 3 and 6. FIG. 6 is a flowchart illustrating the method for acquiring the third image data according to the first embodiment. Before capturing the second image IM of the subject 100 and generating the third image IM-R as illustrated in FIG. 3, the data of the first images IM-P is stored in advance in the PSF storage circuit 73 as described above. The data of the first images IM-P is stored, for example, when the imaging device 1 is designed or shipped, or when the imaging device 1 starts up.

As illustrated in FIGS. 3 and 6, the optical sensor 10 captures the second image IM of the subject 100 (Step ST201). Specifically, the photodiodes 30 of the optical sensor 10 is irradiated with the light that has reflected by the subject 100 and passed through the pinholes PH of the pinhole plate 50. Then, as illustrated in FIG. 2, the imaging circuit 11 processes the detection signals Vdet from the photodiodes 30 and outputs the pixel data Cap. The image generation circuit 72 of the control circuit 70 generates the second image IM of the subject 100 based on a plurality of pieces of the pixel data Cap. The second image IM is an image rotated by 180 degrees with respect to the subject 100.

Then, the first image IM-P corresponding to a distance D between the subject 100 and the pinhole plate 50 is read out (Step ST202). As described above, the PSF storage circuit 73 is stored therein in advance the data of the first images IM-P corresponding to the distances d(n) between the point light source 110 and the pinhole plate 50 (refer to Steps ST103 to ST107 in FIG. 5).

At Step ST202, the distance sensor 75 (refer to FIG. 2) detects the distance D between the subject 100 and the pinhole plate 50. The detected distance D is then compared with the distances d(n) of the first images IM-P, and the first image IM-P at the distance d(n) equal to the detected distance D or closest to the distance D is selected from among the distances d(n). The image processing circuit 74 then reads out, from the PSF storage circuit 73, the first image IM-P corresponding to the selected distance d(n) from among the multiple pieces of image data of the first images IM-P.

As described with reference to FIG. 4, the first images IM-P can also be obtained by calculation. That is, based on the distance detected by the distance sensor 75, the image processing circuit 74 can perform the interpolation processing to make the first image IM-P correspond to the detected distance before the deconvolution process.

The image processing circuit 74 then generates the third image IM-R by performing the deconvolution process based on the second image IM and the first image IM-P obtained by imaging the subject 100 (Step ST203). The image processing circuit 74 can perform the deconvolution process based on Expression (1) below, for example, using Wiener filter.

$$X \approx \hat{X} = W \cdot Y \qquad ( 1 )$$

In Expression (1), X denotes the Fourier transform of the third image IM-R (image without blur); X-hat (X with a superscript \hat{ }) denotes an approximate solution of X; and Y denotes the Fourier transform of an image IM (image with blur) obtained by imaging the subject 100. W denotes the Wiener filter and is a function expressed by Expression (2) below.

$$W = \frac{{H}^{*}}{{\vert H \vert}^{2} + Γ} \qquad ( 2 )$$

In Expression (2), H denotes the Fourier transform of the PSF data (spread function); H* denotes the complex conjugate of H; and Γ denotes a constant that depends on the signal-to-noise ratio (S/N) of the pixel data Cap.

The image processing circuit 74 obtains X-hat (X with a superscript \hat{ }) based on Expressions (1) and (2) using the Wiener filter on the image IM of the subject 100. The image processing circuit 74 can obtain the third image IM-R without blur by taking the inverse Fourier Transform of X-hat (X with a superscript \hat{ }) thus obtained. Since the third image IM-R is an image that is rotated by 180 degrees or is point symmetric with respect to the subject 100, the image is rotated so as to match the subject 100.

The control circuit 70 transmits the third image IM-R to an external host personal computer (PC) 76 (refer to FIG. 2) (Step ST204).

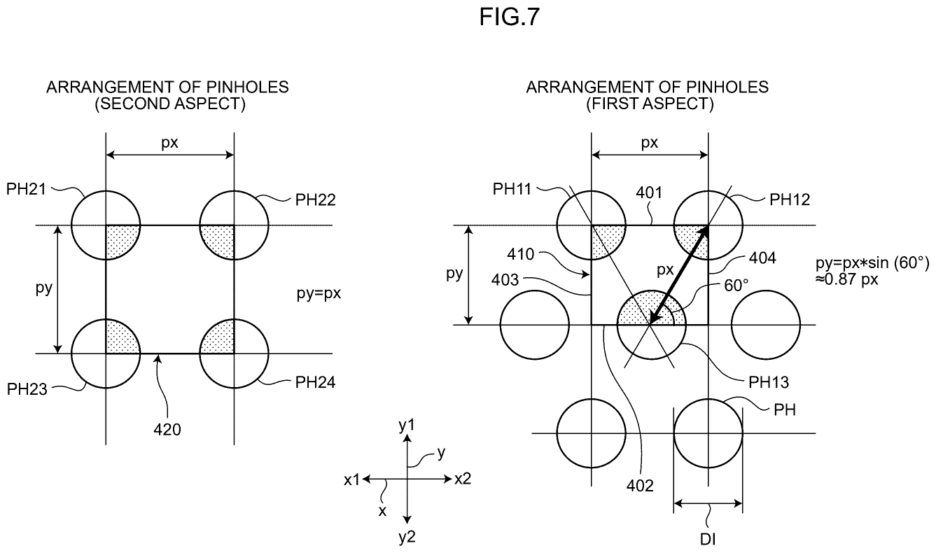

The following describes arrangements of the pinholes PH. FIG. 7 is a schematic diagram explaining the arrangements of the pinholes. The overall outline of the pinholes PH according to a first aspect is a regular hexagonal shape as illustrated in FIG. 4. That is, a regular hexagon is formed by connecting line segments connecting the centers of the pinholes PH located at the outermost ends of the pinholes PH. In the first aspect of the arrangement of the pinholes PH, as illustrated on the right side of FIG. 7, the pinholes PH are arranged in a staggered manner in plan view in the z direction. Specifically, line segments connecting the centers of adjacent three of the pinholes form a regular triangular shape. For example, pinholes PH11, PH12, and PH13 are three adjacent pinholes. Line segments connecting the centers of the pinholes PH11, PH12, and PH13 form a regular triangular shape. A first line segment 401, a second line segment 402, a third line segment 403, and a fourth line segment 404 form a rectangle 410 surrounded by bold lines. The first line segment 401 connects the centers of the pinholes PH11 and PH12. The second line segment 402 is parallel to the first line segment 401 and passes through the center of the pinhole PH13. The third line segment 403 is orthogonal to the first line segment 401 and passes through the center of the pinhole PH11. The fourth line segment 404 is orthogonal to the second line segment 402 and passes through the center of the pinhole PH12. The length of each of the first and second line segments 401 and 402 is a distance px. The length of each of the third and fourth line segments 403 and 404 is a distance py. The distance py is shorter than the distance px because py=px×sin)(60°)≈0.87 px. As illustrated in FIG. 7, when f denotes a focal length and λ denotes a wavelength of light, a diameter DI of the pinhole PH is from 1.4 √fλ to 1.9 √fλ.

The arrangement of the pinholes according to a second aspect is a square array, and line segments connecting the centers of adjacent four of the pinholes have a square shape. For example, pinholes PH21, PH22, PH23, and PH24 are the four adjacent pinholes. Line segments connecting the centers of the pinholes PH21, PH22, PH23 and PH24 form a shape of a square 420 surrounded by bold lines. The length of each of the line segments is the distance px or py. Specifically, py=px.

Portions of the pinholes contained in the rectangle 410 according to the first aspect are shaded with dots. A quarter circle (quadrant) in the pinhole PH11, a quarter circle (quadrant) in the pinhole PH12, and a semicircle in the pinhole PH13 are summed into one circle.

Portions of the pinholes contained in the square 420 according to the second aspect are shaded with dots. Quarter circles (quadrants) in the pinholes PH21, PH22, PH23, and PH24 are summed into one circle.

That is, the total area of the pinholes contained in the rectangle 410 is equal to the total area of the pinholes contained in the square 420, and the area of the rectangle 410 is smaller than the area of the square 420. In other words, the aperture ratio in the first aspect is higher than in the second aspect, thereby being capable of receiving more light.

As described above, the imaging device 1 according to the first embodiment includes the planar optical sensor 10, the pinhole plate 50 provided with the pinholes PH, the PSF storage circuit (storage circuit) 73 that stores therein the first image IM-P, and the image processing circuit (processing circuit) 74 that performs the image processing to generate the third image IM-R by performing the deconvolution process based on the second image IM and the first image IM-P. The first image IM-P is the image indicating the light-dark pattern captured by the optical sensor 10 in the state where the point light source 110 faces the pinhole plate 50 at the predetermined distance. The second image IM is the image obtained by imaging the subject 100 using the optical sensor 10 through the pinholes PH of the pinhole plate 50.

As described above, in JP-A-2024-001293, the focal length needs to be larger, which may increase the overall size of the device. In JP-5839428, the amount of light passing through the pinhole is limited, which may make it difficult to capture clear images.

In contrast, in the present embodiment, the third image IM-R is generated by performing the deconvolution process based on the second image IM and the first image IM-P. Therefore, compared with the imaging device having the lens according to JP-A-2024-001293, the imaging device 1 according to the present embodiment can make the overall size of the device smaller. Since the pinhole camera according to JP-5839428 does not perform the deconvolution process based on the second image IM and the first image IM-P, the imaging device 1 according to the present embodiment can generate clearer images with less blur than the pinhole camera of JP-5839428. From the above, the present embodiment can provide the imaging device 1 having a smaller overall size and being capable of capturing clearer images with reduced blur.

When f is the focal length and λ is the wavelength, the diameter DI of the pinhole PH falls within a range from 1.4 √fλ to 1.9 √fλ.

Setting the diameter DI of the pinhole PH within the above described range makes clearer the first image IM-P and the second image IM captured by the optical sensor 10. In detail, setting the diameter DI of the pinhole PH within the above described range makes clearer the image due to the light passing through one pinhole PH. Since the multiple pinholes PH are provided, the first image IM-P and the second image IM are each formed by superimposing the multiple images corresponding to the respective pinholes PH. Thus, the first image IM-P and the second image IM in each of which the multiple images overlap are also made clearer.

When the pinhole plate 50 is viewed in the Z direction (first direction), the pinholes PH are arranged in a staggered manner.

When the pinhole plate 50 is viewed in the Z direction (first direction), the line segments connecting the centers of adjacent three of the pinholes PH form a regular triangular shape.

Irradiating the optical sensor 10 with a larger amount of light allows the optical sensor 10 to capture a clearer image. As described with reference to FIG. 7, the area of the pinholes PH arranged in the same area is larger in the arrangement of the first aspect (in which the line segments connecting the centers of adjacent three of the pinholes PH form the regular triangular shape) than in the arrangement of the second aspect (in which the line segments connecting the centers of adjacent four of the pinholes PH form the square shape). From the above, the arrangement of the first aspect can irradiate the optical sensor 10 with a larger amount of light.

The distance sensor 75 is further provided to detect the distance between the subject 100 and the pinhole plate 50. Before the deconvolution process, the interpolation processing is performed to enlarge or shrink the first image IM-P to make the first image IM-P correspond to the distance detected by the distance sensor 75.

Even if a large number of the first images IM-P are generated by a large number of imaging operations, in the actual imaging, the distance between the subject 100 and the pinhole plate 50 may differ from the distance mentioned above at which one of the first images IM-P that have already been stored. In that case, a clearer image with reduced blur can be acquired by performing the interpolation processing to enlarge or shrink the stored first image.

### Second Embodiment

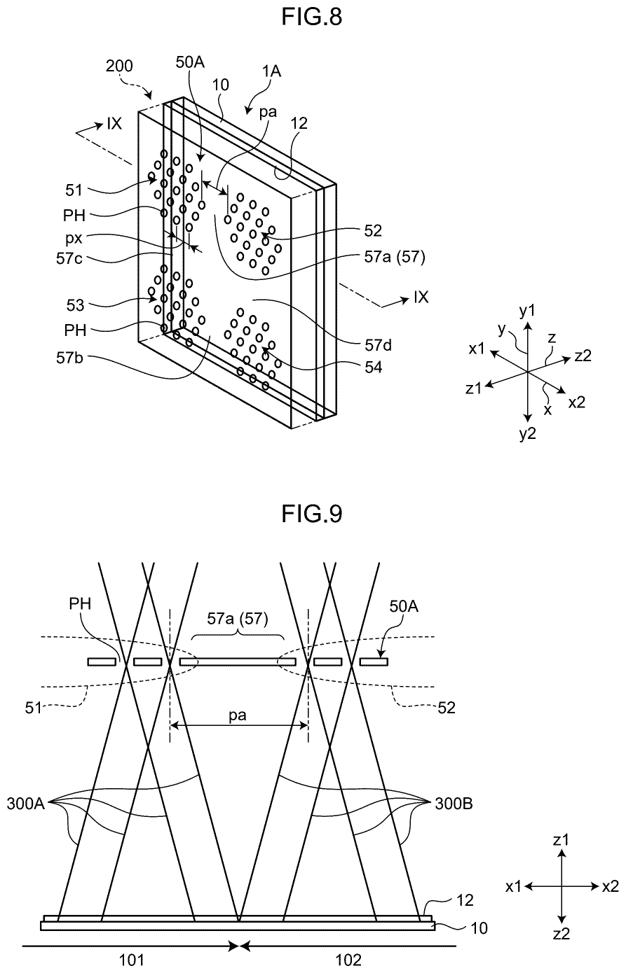

The following describes a second embodiment. FIG. 8 is a perspective view schematically illustrating an imaging device according to a second embodiment of the present disclosure. FIG. 9 is a sectional view taken along line IX-IX in FIG. 8. The second embodiment discloses an aspect of reducing the distance between the pinhole plate (pinhole array) and the optical sensor by combining a plurality of images acquired using a plurality of pinhole groups, thereby reducing the thickness of the imaging device.

The pinhole plate 50 according to the first embodiment is provided with one pinhole group in which a plurality of pinholes PH are arranged at equal intervals. In contrast to this, in a pinhole plate 50A provided in an imaging device 1A according to the second embodiment, a plurality of (in the second embodiment, four) pinhole groups, in each of which a plurality of pinholes PH are arranged at equal intervals, are provided, as illustrated in FIG. 8. Specifically, pinhole groups 51, 52, 53, and 54 are provided, as illustrated in FIG. 8. Adjacent pinhole groups of the pinhole groups 51, 52, 53, and 54 are arranged so as to be spaced from each other.

As illustrated in FIG. 8, the arrangement of the pinholes PH in each of the pinhole groups 51, 52, 53, and 54 is the same as that in the first aspect illustrated on the right side of FIG. 7. As illustrated in FIG. 8, an intermediate area 57 is disposed between each pair of the pinhole groups. In detail, an intermediate area 57a is disposed between the pinhole groups 51 and 52. An intermediate area 57b is disposed between the pinhole groups 53 and 54. An intermediate area 57c is disposed between the pinhole groups 51 and 53. An intermediate area 57d is disposed between the pinhole groups 52 and 54.

As illustrated in FIGS. 7 and 8, distances between the adjacent pinholes PH among the pinholes PH included in one pinhole group are all equal to the distance px. As illustrated in FIG. 8, the distance between the adjacent pinhole groups is a distance pa. The distance pa is larger than the distance px.

In this way, setting the distance pa larger than the distance px prevents light 300A passing through the pinholes PH of the pinhole group 51 from intersecting light 300B passing through the pinholes PH of the pinhole group 52 on the surface of the optical sensor 10, as illustrated in FIG. 9.

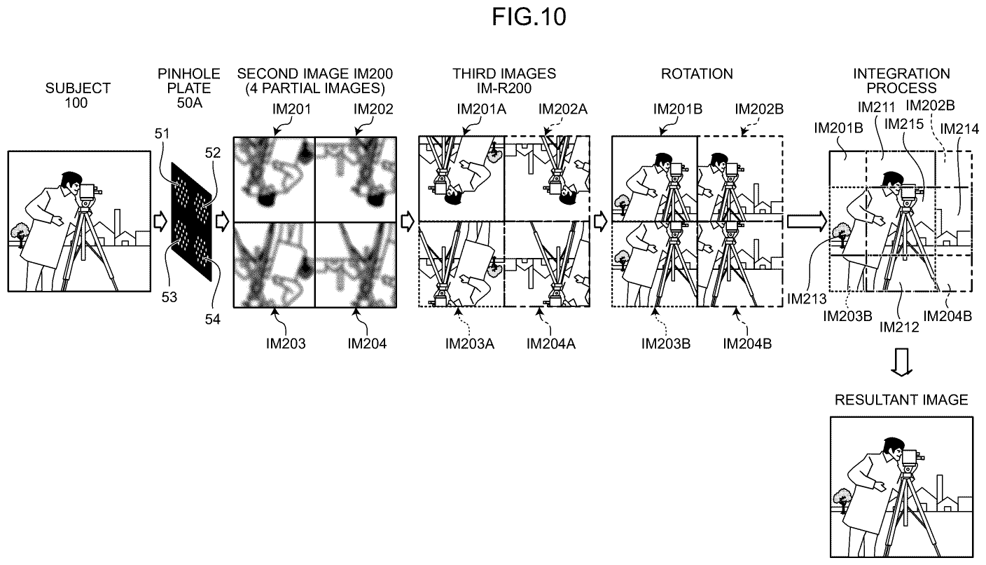

The following briefly describes a procedure to perform the imaging using the pinhole plate 50A. FIG. 10 is a schematic diagram illustrating a procedure of image processing according to the second embodiment.

As illustrated in FIG. 10, the pinhole plate 50A according to the second embodiment has four pinhole groups. Therefore, the light from the subject 100 passes through each of the four pinhole groups 51, 52, 53, and 54. Thus, a second image IM200 includes four partial images corresponding to the light rays transmitted through the respective pinhole groups 51, 52, 53, and 54. Specifically, the four partial images are partial images IM201, IM202, IM203, and IM204.

The deconvolution process is individually performed on the four partial images IM201, IM202, IM203, and IM204 to generate four third images IM-R200. The four third images IM-R200 are, specifically, third images IM201A, IM202A, IM203A, and IM204A. The third images IM201A, IM202A, IM203A, and IM204A are, then, rotated to obtain images IM201B, IM202B, IM203B, and IM204B.

These images IM201B, IM202B, IM203B, and IM204B are then integrated. In the integration process, overlapping portions corresponding to the same imaging areas in the above-mentioned four generated third images are integrated. For example, the images IM201B and IM202B include an image IM211 that is the same imaging area. Therefore, when integrating the images IM201B and IM202B, the image IM211 of the image IM201B and the image IM211 of the image IM202B that are each an overlapping portion, are integrated. The images IM203B and IM204B include an image IM212 that is the same imaging area. Therefore, when integrating the images IM203B and IM204B, the image IM212 of the image IM203B and the image IM212 of the image IM204B that are each an overlapping portion, are integrated. In the same way, when integrating the images IM201B and IM203B each including an image IM213 as an overlapping portion, the image IM213 of the images IM201B and the image IM213 of the image IM203B are integrated. When integrating the images IM202B and IM204B each including an image IM214 as an overlapping portion, the image IM214 of the image IM202B and the image IM214 of the image IM204B are integrated.

Thus, a composition process is performed in which the four third images are generated by individually performing the deconvolution process on the four (multiple) partial images, and the overlapping portions corresponding to the same imaging areas in the four generated third images are integrated. The image processing circuit (processing circuit) 74 (refer to FIG. 2) performs the composition process. The composition process generates a resultant image.

In the composition process, the average value of gradation values of each of the integrated pixels is set as a gradation value of the pixel after the integration. For example, when integrating the images IM201B and IM202B each including the image IM211 as the overlapping portion, the image IM211 of the image IM201B and the image IM211 of the image IM202B are integrated, and each of the gradation values of the pixels of the image IM211 is set to the average value of the gradation values of the pixels of the images IM201B and IM202B.

As described above, the second image IM200 according to the second embodiment includes the partial images IM201, IM202, IM203, and IM204 corresponding to the light transmitted through the pinhole groups 51, 52, 53, and 54, respectively. The image processing circuit (processing circuit) 74 performs the composition process. The composition process is a process to generate the third images IM201A, IM202A, IM203A, and IM204A by individually performing the deconvolution process (image restoration calculation process) on the partial images IM201, IM202, IM203, and IM204, and integrate the overlapping portions IM211, IM212, IM213, IM214, and IM215 corresponding to the same imaging areas in the generated third images.

Since this process integrates the partial images IM201, IM202, IM203, and IM204 corresponding to the light rays transmitted through the pinhole groups 51, 52, 53, and 54, respectively, the thickness of the imaging device can be reduced by narrowing the distance between the pinhole plate 50A and the optical sensor 10.

The composition process is a process to set the gradation value of the pixel in the integrated portion to the average value of gradation values of the corresponding pixels in the overlapping portions that are integrated.

As described with reference to FIG. 10, for example, when integrating the images IM201B and IM202B, the images IM211 of the images IM201B and IM202B that are the overlapping portions are integrated, and the gradation value of the pixel of the integrated image IM211 is set to the average value of the gradation values of the pixels of the images IM201B and IM202B. This processing makes the colors and brightness uniform between the image IM201B, the image IM202B, and the image IM211 that is the overlapping portion, resulting in an image with more natural colors and brightness.

### First Modification

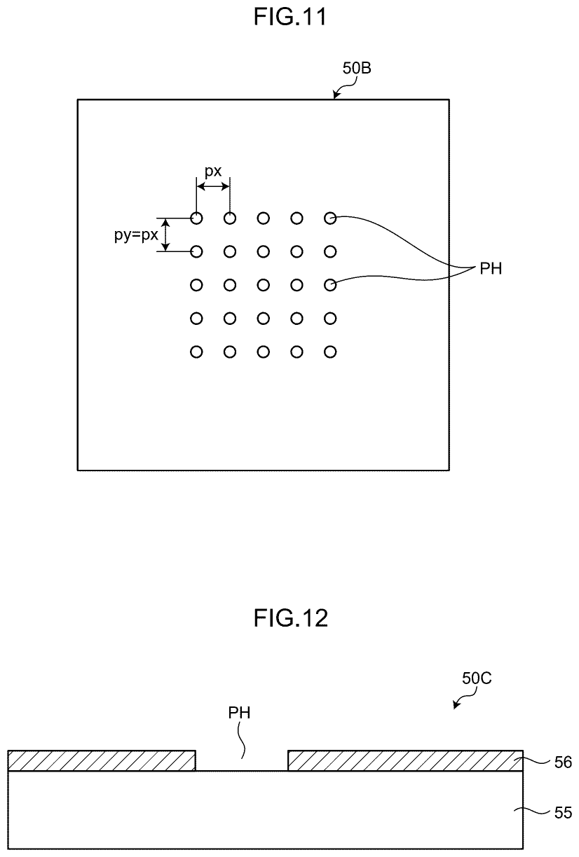

FIG. 11 is a plan view of a pinhole plate according to a first modification. As illustrated in a pinhole plate 50B according to the first modification, the pinholes PH may be arranged in a square arrangement in plan view. This arrangement is the same as that of the second aspect illustrated in FIG. 7. The distance px is equal to the distance py between the adjacent pinholes PH.

This arrangement is more advantageous than the staggered arrangement in allowing an easier forming operation of the pinholes PH.

### Second Modification

FIG. 12 is a schematic sectional view of a pinhole plate according to a second modification. As illustrated in a pinhole plate 50C according to the second modification, a non-light-transmitting film 56 may be formed on a surface of a light-transmitting glass 55, and a portion where the non-light-transmitting film 56 is not formed may be used as the pinhole PH.

This configuration makes the formation of the pinholes PH easier than an aspect where the pinholes PH are punched through the pinhole plate.

### Third Embodiment

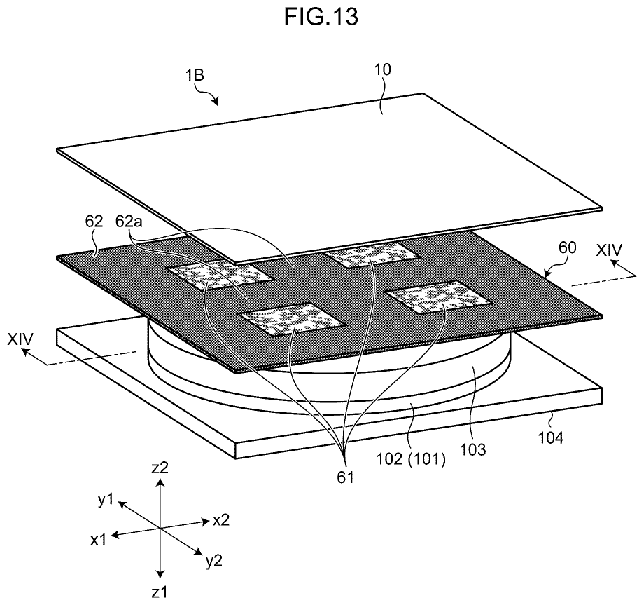

The following describes a third embodiment of the present disclosure. FIG. 13 is an exploded perspective view schematically illustrating an imaging device according to the third embodiment. The third embodiment discloses a mode of the image processing using a code mask sheet provided with a code pattern. The distance sensor to detect the distance between a subject 101 and a code mask sheet 60 is applied also in the third embodiment.

As illustrated in FIG. 13, an imaging device 1B according to the third embodiment include the optical sensor 10, the code mask sheet 60, a subject housing 103, and a light source 104. The optical sensor 10, the code mask sheet 60, the subject housing 103, and the light source 104 are stacked in this order from the z2 side to the z1 side. The z1 side is also referred to as one side in the first direction, and the z2 side is also referred to as the other side in the first direction. That is, the code mask sheet 60 is located on the z1 side of the optical sensor 10; the subject housing 103 is located on the z1 side of the code mask sheet 60; and the light source 104 is located on the z1 side of the subject housing 103.

The optical sensor 10 is a planar detection device including the photodiodes 30 (photodetection elements) arranged in a planar configuration. The optical sensor 10 according to the third embodiment includes the array substrate 2 illustrated in FIG. 2, and the sensor pixels 3 (photodiodes 30), the gate line drive circuits 15A and 15B, the signal line drive circuit 16A, and the imaging circuit 11 formed on the array substrate 2, in the same way as the optical sensor 10 according to the first embodiment.

The code mask sheet 60 includes four (multiple) code patterns 61. The code mask sheet 60 includes the four code patterns 61 and a light-blocking area 62 located outside the code patterns 61. The four code patterns 61 have the same configuration. The four code patterns 61 are arranged in a matrix having a row-column configuration. Specifically, the four code patterns 61 are arranged two in the x direction and two in the y direction. An intermediate area 62a is provided between two of the code patterns 61 arranged in the x direction and between two of the code patterns 61 arranged in the y direction. The intermediate area 62a is a portion of the light-blocking area 62. The code mask sheet 60 will be described later in detail.

The subject housing 103 accommodates the subject 101. The subject housing 103 is a light-transmitting container, such as a Petri dish, for example. The subject 101 is, for example, microorganisms 102b located on a surface 102a of a culture medium 102 (e.g., agar). Specifically, the culture medium 102 is accommodated in the Petri dish; the microorganisms 102b are cultured on the culture medium 102; and the growth of the microorganisms 102b is imaged.

The light source 104 is, for example, a backlight formed in a planar shape. Specifically, The light source 104 includes a plurality of light-emitting diodes (LEDs) or the like arranged in a planar shape to emit light uniformly.

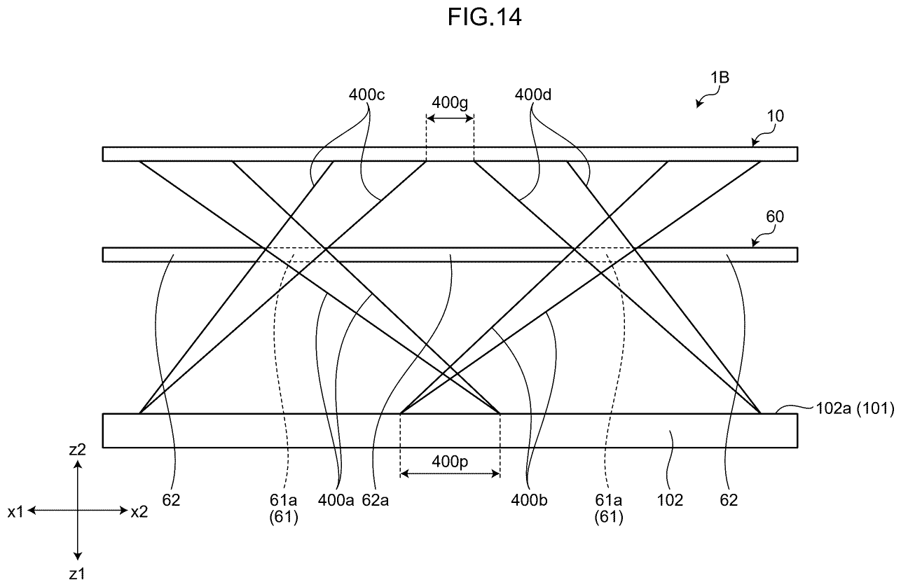

FIG. 14 is a schematic sectional view taken along line XIV-XIV in FIG. 13. As described above, the code mask sheet 60 is placed on the z2 side of the culture medium 102, and the optical sensor 10 is placed on the z2 side of the code mask sheet 60. The light source 104 illustrated in FIG. 13 is placed on the z1 side of the culture medium 102. With this configuration, light is emitted from the light source 104 toward the culture medium 102, passes through the surface 102a of the culture medium 102, then passes through light-transmitting portions 61a of the code patterns 61 of the code mask sheet 60, and then reaches the optical sensor 10.

Specifically, FIG. 14 illustrates two code patterns 61: a code pattern 61 on the x1 side and a code pattern 61 on the x2 side. Light passing through the code pattern 61 on the x1 side is light 400a and light 400c. Light passing through a code pattern 61 on the x2 side is light 400b and light 400d. The light passing through the code pattern 61 on the xl side and the light passing through the code pattern 61 on the x2 side overlap each other in the x direction on the surface 102a of the culture medium 102. Thus, an overlapping portion 400p where the light 400a overlaps the light 400b, is formed on the surface 102a of the culture medium 102. The light passing through the code pattern 61 on the x1 side and the light passing through the code pattern 61 on the x2 side are separated from each other in the x direction on the optical sensor 10. Thus, a separation portion 400g is formed between the light 400c and the light 400d on the optical sensor 10.

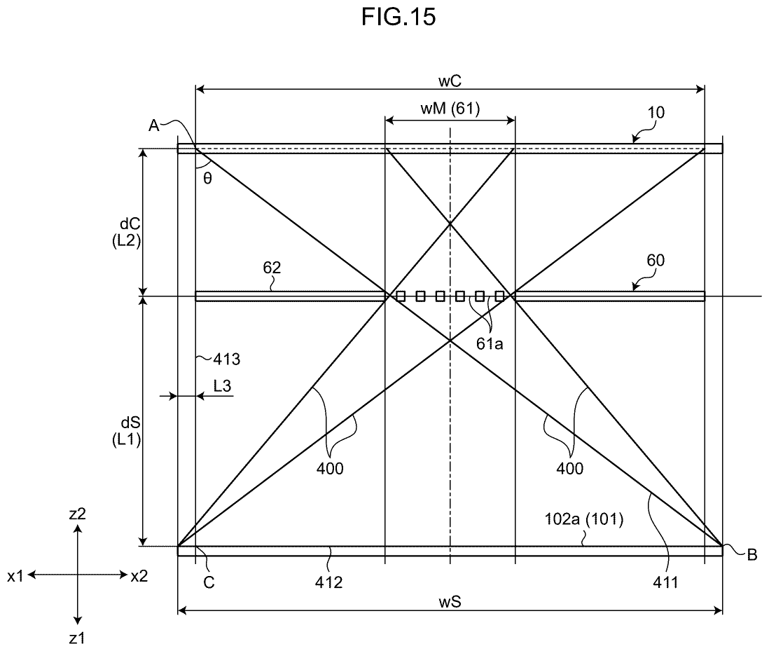

Subsequently, the distance in the z direction from the optical sensor to the surface of the culture medium is calculated. FIG. 15 is an enlarged schematic view of a portion of FIG. 14. wS denotes the width in the x direction of the subject (specifically, the width of the surface of the culture medium); wM denotes the width in the x direction of the code pattern; WC denotes the irradiation width on the optical sensor; dS denotes the distance in the z direction from the code mask sheet to the subject; dC denotes the distance in the z direction from the optical sensor to the code mask sheet; and θ denotes the light receiving range angle of the optical sensor.

ds is also referred to as a “first distance L1” and dc is also referred to as a “second distance L2”. Light 400 is light that is emitted from the surface 102a of the culture medium 102 toward the z2 side and passes through the light-transmitting portions 61a of the code pattern 61. In FIG. 15, a first side 411, a second side 412, and a third side 413 form a right triangle ABC. The first side 411 is a side corresponding to the light 400. The second side 412 is a side corresponding to the width wS in the x direction of the subject 101. The third side 413 is a side extending from an intersection A of the first side 411 and the optical sensor 10 toward the z1 side, reaching the surface 102a of the culture medium 102.

First, a third distance L3 is (wS−wC)/2. The length of the second side 412 is (wS−third distance L3). (length of second side 412)=(length of third side 413)×tanθ, where (length of third side 413)=(dC+dS). Therefore, Expression (6) can be derived from Expression (3) given below.

$$wS - \frac{wS - wC}{2} = ( dS + dC ) tan θ \qquad ( 3 )$$

$$\frac{wS + wC}{2} = ( dS + dC ) tan θ \qquad ( 4 )$$

$$tan θ = \frac{wS + wC}{2 ( dS + dC )} \qquad ( 5 )$$

$$dS + dC = \frac{wS + wC}{2 \cdot tan θ} \qquad ( 6 )$$

Expression (6) indicates that (wS+wC) is proportional to (ds+dC). Therefore, the distance in the z direction from the optical sensor 10 to the surface 102a of the culture medium 102 is reduced by reducing the width (wS) in the x direction of the subject and the irradiation width (wC) on the optical sensor, thereby downsizing the imaging device 1B.

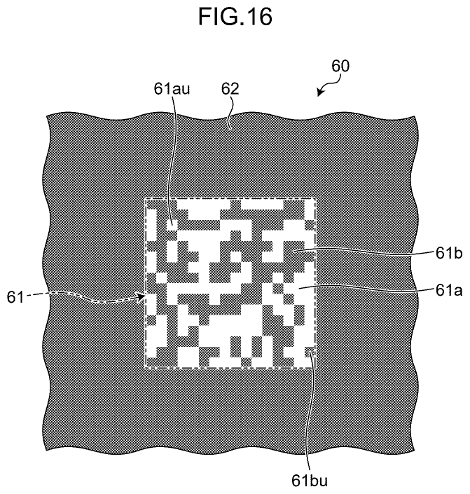

The following describes the code pattern. FIG. 16 is a schematic enlarged view of the code mask sheet. The code mask sheet 60 includes the code pattern 61 and the light-blocking area 62. In the present embodiment, the code pattern 61 has a square outline in plan view. The light-blocking area 62 is located outside the code pattern 61. A graphic pattern in the shape of a QR code (registered trademark) can be applied to the code pattern 61. The code pattern 61 includes the light-transmitting portions 61a and light-blocking portions 61b. The light-transmitting portions 61a have a higher degree of transmittance than the light-blocking portions 61b. The light-blocking portions 61b have the same degree of transmittance as the light-blocking area 62.

The light-transmitting portions 61a and the light-blocking portions 61b are formed by arranging one small square or two or more small squares connected to each other. Specifically, the light-transmitting portions 61a in FIG. 16 are formed by arranging a plurality of squares 61au serving as constitutional units. The light-transmitting portions 61a include portions each including one square 61au and portions each including two or more connected squares 61au. In the same way, the light-blocking portions 61b in FIG. 16 are formed by arranging a plurality of squares 61bu serving as constitutional units. The light-blocking portions 61b include portions each including one square 61bu and portions each including two or more connected squares 61bu.

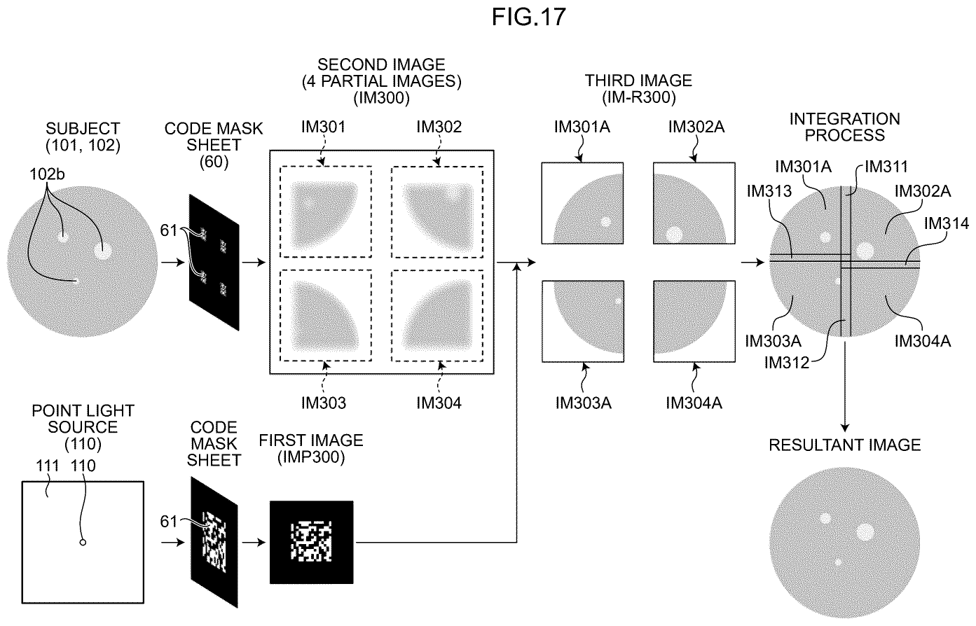

The following briefly describes a procedure to perform the imaging using the code mask sheet 60. FIG. 17 is a schematic diagram illustrating a procedure of image processing according to the third embodiment.

As illustrated in FIG. 17, first, a plurality of first images IMP300 corresponding to a plurality of distances are acquired by varying the distance between the point light source 110 and the code mask sheet 60. As a result, the PSF storage circuit 73 illustrated in FIG. 2 stores therein the first images IMP300 indicating a light-dark pattern captured by the optical sensor 10 in the state where the point light source 110 faces the code mask sheet 60 at a predetermined distance.

As illustrated in FIG. 17, the code mask sheet 60 according to the third embodiment has the four code patterns 61, so that light from the subject 101 passes through each of the four code patterns 61. Thus, a second image IM300 includes four partial images corresponding to the light rays transmitted through the four respective code patterns 61. Specifically, the four partial images are partial images IM301, IM302, IM303, and IM304.

The four partial images IM301, IM302, IM303, and IM304 are individually deconvolved and separately rotated to obtain third images IM-R300. The third images IM-R300 are images IM301A, IM302A, IM303A, and IM304A.

These images IM301A, IM302A, IM303A, and IM304A are then integrated. In the integration process, overlapping portions corresponding to the same imaging areas in the above-mentioned four generated third images are integrated. For example, the images IM301A and IM302A include an image IM311 that is the same imaging area. Therefore, when integrating the images IM301A and IM302A, the image IM311 of the image IM301A and the image IM311 of the image IM302A that are each an overlapping portion, are integrated. The images IM303A and IM304A include an image IM312 that is the same imaging area. Therefore, when integrating the images IM303A and IM304A, the image IM312 of the image IM303A and the image IM312 of the image IM304A that are each an overlapping portion, are integrated. In the same way, when integrating the images IM301A and IM303A each including an image IM313 as an overlapping portion, the image IM313 of the image IM301A and the image IM313 of the image IM303A are integrated. When integrating the images IM302A and IM304A each including an image IM314 as an overlapping portion, the image IM314 of the image IM302A and the image IM314 of the image IM304A are integrated.

Thus, a composition process is performed in which the four third images are generated by individually performing the deconvolution process on the four (multiple) partial images, and the overlapping portions corresponding to the same imaging areas in the four generated third images are integrated. The image processing circuit (processing circuit) 74 (refer to FIG. 2) performs the composition process. The composition process generates a resultant image.

In the composition process, the average value of gradation values of each of the integrated pixels is set as a gradation value of the pixel after the integration. For example, when integrating the images IM301A and IM302A each including the image IM311 as the overlapping portion, the image IM311 of the image IM301A and the image IM311 of the image IM302A are integrated, and each of the gradation values of the pixels of the image IM311 is set to the average value of the gradation values of the pixels of the images IM301A and IM302A.

As described above, the imaging device 1B according to the third embodiment includes the planar optical sensor 10, the code mask sheet 60 including the code patterns 61 and the light-blocking area 62, the PSF storage circuit 73 (storage circuit) that stores therein the first images IMP300 indicating the light-dark pattern captured by the optical sensor 10 in the state where the point light source faces the code mask sheet 60 at the predetermined distance, and the image processing circuit 74 (processing circuit) that performs the image processing to generate the third image IM-R300 by performing the image restoration calculation process (deconvolution process) based on the first images IMP300 and the second image IM300. Each of the code patterns 61 includes the light-transmitting portions 61a and the light-blocking portions 61b.

Thus, the third embodiment also provides the same operational advantages as those of the first embodiment. However, comparing the pinhole plate 50 provided with the pinhole PH to the code mask sheet 60 provided with the code pattern 61, the code mask sheet 60 has a larger area ratio for light transmission. This is because, comparing the total area of the pinholes PH and the total area of the light-transmitting portions 61a of the code pattern 61 per square having the same area, the total area of the light-transmitting portions 61a of the code pattern 61 can be set larger. Therefore, according to the third embodiment, the imaging device 1B capable of capturing brighter images can be provided.

The proportion of the total area of the light-transmitting portions 61a within the entire code patterns 61 is 40% to 60%. When the proportion of the total area is less than 40%, the images are darkened; and when the proportion of the total area is more than 60%, the quality of the image restoration calculation is degraded. Therefore, the proportion of 40% to 60% is preferable to obtain the images with appropriate brightness.

The second image IM300 includes the partial images IM301, IM302, IM303, and IM304 corresponding to the rays of light transmitted through the respective code patterns 61. The image processing circuit 74 (processing circuit) generates a plurality of the third images IM-R300 and performs the composition process to integrate the overlapping portions corresponding to the same imaging area in the generated third images IM-R300. With this process, the partial images IM301A, IM302A, IM303A, and IM304A of the third image IM-R300 corresponding to the rays of light transmitted through the respective code patterns 61 are integrated. Therefore, the distance between the code mask sheet 60 and the optical sensor 10 can be reduced to reduce the thickness of the imaging device 1B.

The composition process is the process to set the gradation value of the pixel in the integrated portion to the average value of gradation values of the corresponding pixels in the overlapping portions that are integrated. This processing makes the colors and brightness uniform between the images IM301A, IM302A, IM303A, and IM304A and the images IM311, IM312, IM313, and IM314 that are the overlapping portions, resulting in an image with more natural colors and brightness.

The code mask sheet 60 is stacked on the z1 side on the optical sensor 10. The subject housing 103 is stacked on the z1 side of the code mask sheet 60. The light source 104 is stacked on the z1 side of the subject housing 103. Thus, the respective members are stacked in the z direction (first direction), so that the more compact imaging device 1B is obtained.

The distance in the z direction between the subject 101 and the code mask sheet 60 is larger than the distance in the z direction between the code mask sheet 60 and the optical sensor 10. This configuration can easily reduce the overlapping of rays of light passing through adjacent two of the code patterns 61, on the optical sensor 10.

The code patterns 61 are arranged in a matrix having a row-column configuration when viewed in the z direction. If, for example, the code patterns 61 are arranged along the row or column direction, the code mask sheet 60 has an elongated rectangular shape extending in the row or column direction. Therefore, by arranging the code patterns 61 in a matrix having a row-column configuration, the code mask sheet 60 having a rectangular shape extending both row and column directions can be obtained.

In the image processing circuit 74 (processing circuit), before the image restoration calculation process, the interpolation processing is performed to enlarge or shrink the first images IMP300 to make the first images IMP300 correspond to the distance detected by the distance sensor. According to this processing, in the same way as in the first embodiment, a clearer image with reduced blur can be acquired by performing the interpolation processing to enlarge or shrink the stored first images IMP300. While the preferred embodiments of the present disclosure have been described above, the present disclosure is not limited to the embodiments described above. The content disclosed in the embodiments is merely an example, and can be variously modified within the scope not departing from the gist of the present disclosure. Any modifications appropriately made within the scope not departing from the gist of the present disclosure also naturally belong to the technical scope of the present disclosure. At least one of various omissions, substitutions, and modifications of the components can be made without departing from the gist of the embodiments and the modifications described above.

What is claimed is:

1. An imaging device comprising:
a planar optical sensor comprising a plurality of photodiodes;
a pinhole plate stacked in a first direction with respect to the optical sensor and provided with a plurality of pinholes;
a storage circuit configured to store therein a first image indicating a light-dark pattern captured by the optical sensor in a state where a point light source faces the pinhole plate at a predetermined distance; and
a processing circuit configured to perform image processing to generate a third image by performing an image restoration calculation process based on the first image and a second image that is obtained by imaging a subject using the optical sensor through the pinholes of the pinhole plate.

2. The imaging device according to claim 1, wherein, when f denotes a focal length, and λ denotes a wavelength of light, a diameter DI of the pinholes is from 1.41 √fλ to 1.9 √fλ.

3. The imaging device according to claim 2, wherein the pinholes are arranged in a staggered manner when the pinhole plate is viewed in the first direction.

4. The imaging device according to claim 3, wherein line segments connecting centers of adjacent three of the pinholes form a regular triangular shape when the pinhole plate is viewed in the first direction.

5. The imaging device according to claim 1, further comprising a distance sensor configured to detect a distance between the subject and the pinhole plate, wherein
interpolation processing is performed in the processing circuit to enlarge or shrink the first image to make the first image correspond to the distance detected by the distance sensor, before the image restoration calculation process.

6. The imaging device according to claim 5, comprising a plurality of pinhole groups, in each of which the pinholes are arranged at equal intervals, and a distance between adjacent pinhole groups among the pinhole groups is larger than a distance between adjacent pinholes among the pinholes included in each of the pinhole groups.

7. The imaging device according to claim 6, wherein
the second image includes a plurality of partial images corresponding to rays of light transmitted through the respective pinhole groups, and
the processing circuit is configured to individually perform the image restoration calculation process on the partial images to generate a plurality of the third images and perform a composition process to integrate overlapping portions corresponding to a same imaging area in the generated third images.

8. The imaging device according to claim 7, wherein the composition process is a process to set a gradation value of a pixel in an integrated portion to an average value of gradation values of corresponding pixels in the overlapping portions that are integrated.

9. The imaging device according to claim 1, wherein the image restoration calculation process is a deconvolution process.

10. An imaging device comprising:
a planar optical sensor comprising a plurality of photodiodes;
a code mask sheet stacked in a first direction with respect to the optical sensor and provided with a plurality of code patterns and a light-blocking area located outside the code patterns;
a storage circuit configured to store therein a first image indicating a light-dark pattern captured by the optical sensor in a state where a point light source faces the code mask sheet at a predetermined distance; and
a processing circuit configured to perform image processing to generate a third image by performing an image restoration calculation process based on the first image and a second image that is obtained by imaging a subject using the optical sensor through the code patterns of the code mask sheet, wherein
each of the code patterns includes light-transmitting portions and light-blocking portions.

11. The imaging device according to claim 10, wherein a total area of the light-transmitting portions in the entire code patterns is 40% to 60% of a total area of the code patterns.

12. The imaging device according to claim 10, wherein
the second image includes a plurality of partial images corresponding to rays of light transmitted through the respective code patterns, and
the processing circuit is configured to individually perform the image restoration calculation process on the partial images to generate a plurality of the third images and perform a composition process to integrate overlapping portions corresponding to a same imaging area in the generated third images.

13. The imaging device according to claim 12, wherein the composition process is a process to set a gradation value of a pixel in an integrated portion to an average value of gradation values of corresponding pixels in the overlapping portions that are integrated.

14. The imaging device according to claim 10, wherein
the code mask sheet is stacked on one side in the first direction with respect to the optical sensor,
a subject housing configured to accommodate the subject is stacked on one side in the first direction with respect to the code mask sheet, and
a light source is stacked on one side in the first direction with respect to the subject housing.

15. The imaging device according to claim 14, wherein a distance in the first direction between the subject and the code mask sheet is larger than a distance in the first direction between the code mask sheet and the optical sensor.

16. The imaging device according to claim 14, wherein the code patterns are arranged in a matrix having a row-column configuration when viewed in the first direction.

17. The imaging device according to claim 10, further comprising a distance sensor configured to detect a distance between the subject and the code mask sheet, wherein
interpolation processing is performed in the processing circuit to enlarge or shrink the first image to make the first image correspond to the distance detected by the distance sensor, before the image restoration calculation process.

18. The imaging device according to claim 10, wherein the image restoration calculation process is a deconvolution process.
